(19) United States
(12) Patent Application Publication
(10) Pub. No.: US 2018/0050933 A1
(43) Pub. Date: Feb. 22, 2018

(54) METHODS FOR RECLAIMING PRODUCED WATER

(71) Applicant: Naveed Aslam, Houston, TX (US)

(72) Inventor: Naveed Aslam, Houston, TX (US)

(21) Appl. No.: 15/238,284

(22) Filed: Aug. 16, 2016

(51) Int. Cl. C02F 1/44; B01D 61/00; B01D 71/40; B01D 71/28; C02F 1/52

(52) U.S. Cl. CPC C02F 1/445; B01D 61/005; C02F 2103/10; B01D 71/28; C02F 1/52; B01D 71/40

(57) ABSTRACT

A method for treating produced water from a fraccing source is disclosed. The method first mixes nitrogen and produced water and feeds the mixture to a forward osmosis unit containing a semi-permeable membrane; carbon dioxide gas is then fed to the forward osmosis unit, therein creating a pressurized nitrogen side and a pressurized carbon dioxide side of the forward osmosis unit; concentrated produced water is recovered from the pressurized nitrogen side of the forward osmosis unit and fresh water is recovered from the pressurized carbon dioxide side of the forward osmosis unit.

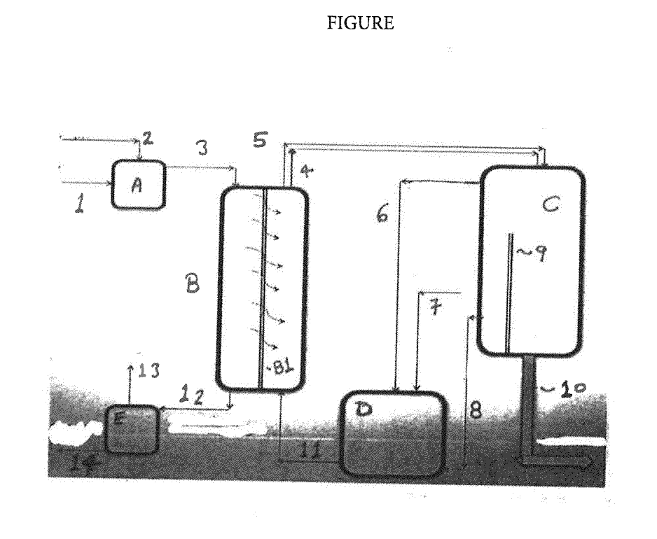

### BACKGROUND OF THE INVENTION

Hydraulic fracturing is becoming a desirable method for extracting hydrocarbons. However, this method is being given scrutiny by public and regulatory agencies due to their extensive requirement for and consumption of water.

This problem is exacerbated in certain regions of the United States because there is a water shortage to contend with. The Permian Basin in Texas is one such area so there is a continuous need for methods that use water more efficiently in the hydraulic fracturing operations.

The present invention utilizes a forward osmosis unit to concentrate and produce fresh water from oil and gas produced water using feeds of nitrogen and carbon dioxide to the forward osmosis unit.

### SUMMARY OF THE INVENTION

In one embodiment of the invention there is disclosed a method for treating produced water comprising the steps of:
a) Mixing nitrogen and produced water and feed the mixture to a forward osmosis unit containing a semi-permeable membrane;
b) Feeding carbon dioxide gas to the forward osmosis unit, therein creating a pressurized nitrogen side and a pressurized carbon dioxide side of the forward osmosis unit;
c) Recovering concentrated produced water from the pressurized nitrogen side of the forward osmosis unit; and
d) Recovering fresh water from the pressurized carbon dioxide side of the forward osmosis unit.

The nitrogen and carbon dioxide gases that are fed to the forward osmosis unit in steps a) and b) above are at high pressure. Typically, this high pressure is between about 5 to about 30 bars.

Alternatively, the nitrogen could be replaced by an inert gas selected from the group consisting of helium, argon and mixtures thereof.

The concentrated produced water that is recovered from the pressurized nitrogen side of the forward osmosis unit is fed to a concentrator which will separate the nitrogen gas dissolved in the concentrated produced water from the concentrated produced water and vented.

The fresh water that is recovered from the pressurized carbon dioxide side of the forward osmosis unit is fed to a separation device. Recovered carbon dioxide gas from the pressurized carbon dioxide side of the forward osmosis unit is also fed to the separation device.

In the forward osmosis unit, the osmotic pressure in the produced water is lower due to the presence of salts therein. Conversely, the osmotic pressure in the gas driven draw solution is higher. This creates a driving force within the forward osmosis unit. This driving force makes the water from the produced water move into the draw solution in its attempt to lower its osmotic pressure. In this manner, the water is separated through the natural driving force unlike reverse osmosis for example where hydraulic pressure is increased through the use of the pump.

The semi-permeable membrane allows for the passage of certain molecules and not others and is typically made from polymers with special coatings such as poly imides and carbonates such as polyvinyl carbonates.

The fresh water will be further separated as such from the carbon dioxide gas in the separation device and recovered for reuse or as potable water.

The carbon dioxide gas separated out may be fed to a concentrator unit where it will combine with a feed of pressurized carbon dioxide gas for feed into the pressurized carbon dioxide side of the forward osmosis unit.

Phase II liquid will also be recovered from the separation device and fed to the concentrator unit. The Phase II liquid could provide enhanced solubility of carbon dioxide. When it is fed to a concentrator, it forms a two phase draw solution which under pressure from a carbon dioxide fresh feed is fed to the forward osmosis unit for separation of water from the produced water.

The methods of the present invention are applicable to any produced water with produced waters having lower concentrations of contaminants preferred.

The average produced water composition is described as follows: i.e., minimum, maximum and average:

| Constituent | Average | Maximum | Minimum |
|---|---|---|---|
| COD (mg/L) | 3,000 | 7,900 | 300 |
| pH | 7 | 8 | 6 |
| TDS (mg/L) | 150,000 | 400,000 | 1,000 |
| TSS (mg/L) | 1,200 | 13,800 | 10 |
| O&G (mg/L) | 800 | 1,000 | 600 |
| Iron (mg/L) | 100 | 300 | 3 |
| Barium (mg/L) | 1,600 | 9,000 | 1 |
| Strontium (mg/L) | 2,000 | 6,300 | 40 |
| Sulfate (mg/L) | 1,200 | 15,000 | 10 |
| Sodium (mg/L) | 36,000 | 150,000 | 3,300 |
| Chlorine (mg/L) | 88,000 | 250,000 | 5,000 |
| Bicarbonate (mg/L) | 1,800 | 15,000 | 80 |
| Calcium (mg/L) | 10,200 | 74,000 | 300 |
| Total Organic Carbon (mg/L) | 800 | 7,200 | 60 |

The produced water is characterized by very high dissolved salts or solids. On average these amounts are around 150,000 PPM. With this amount of dissolved salts or solids, produced water is typically beyond the capabilities of a traditional reverse osmosis (RO) unit.

### BRIEF DESCRIPTION OF THE DRAWINGS

The FIGURE is a schematic of a method for producing and concentrating fresh water from oil and gas produced water per the invention.

### DETAILED DESCRIPTION OF THE INVENTION

Turning to the FIGURE, a method for treating produced water from an oil and gas source is shown. Produced water is fed through line 1 to a mixing chamber A where it will be mixed with high pressure nitrogen fed through line 2. The produced water will contain a number of impurities including particulate materials and hydrocarbons from the well and any fraccing treatments.

The mixture of produced water and high pressure nitrogen is fed from mixing chamber A to a forward osmosis unit B which contains a semi-permeable membrane B1. The effects of this forward osmosis unit B is to drive by way of osmotic pressure to separate the feed of produced water from the solutes present therein. As such, a concentrated solution of produced water will be fed through line 12 to a concentrator E. This concentrated solution of produced water also contains some nitrogen which will be vented from the concentrator E through line 13. The concentrated produced water from concentrator E can be fed to a crystallizer or it can be discharged and disposed of.

The concentrator E will produce concentrated produced water which will be fed through line 14 for further treatment. The concentrator units in general will adjust the concentrations of solutes in the draw solution for reliable operation of the forward osmosis unit B.

Pressurized carbon dioxide gas is fed through line 7 to a concentrator D which will also receive through line 8 Phase II liquid a separation device C. The pressurized carbon dioxide will dissolve in the Phase II liquid and be fed through line 11 to the forward osmosis unit B. Because the carbon dioxide will provide higher osmotic pressure on the carbon dioxide side of the semi-permeable membrane, the fresh water from the produced water will diffuse into the carbon dioxide side of the forward osmosis unit B. This fresh water is recovered and fed through line 4 to the separation device C. The separation unit C will separate phases. For example, fresh water being relatively heavier will settle at the bottom while the organic draw solution, being relatively lighter floats on the water layer. This organic draw solution can be mixed with fresh carbon dioxide to be recycled for further drawing of the water from the produced water.

Carbon dioxide gas will also be recovered from the carbon dioxide side of the semi-permeable membrane and be fed through line 5 to the separation device C. A gravity separator 9 is present in the separation unit C.

The separation device C will separate the fresh water from the Phase II liquid and be recovered through line 10 for reuse in the fraccing operation or as potable water. Carbon dioxide gas which has been separated will be fed through line 6 to the concentrator D where it can join with the pressurized carbon dioxide gas fed through line 7 into the concentrator thereby supplementing the amount of fresh pressurized carbon dioxide gas needed.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. A method for treating produced water comprising the steps of:
a) Mixing nitrogen and produced water and feeding the mixture to a forward osmosis unit containing a semi-permeable membrane;
b) Feeding carbon dioxide gas to the forward osmosis unit, therein creating a pressurized nitrogen side and a pressurized carbon dioxide side of the forward osmosis unit;
c) Recovering concentrated produced water from the pressurized nitrogen side of the forward osmosis unit; and
d) Recovering fresh water from the pressurized carbon dioxide side of the forward osmosis unit.

2. The method as claimed in claim 1 wherein the nitrogen and carbon dioxide that are fed to the forward osmosis unit in steps a) and b) are at high pressure.

3. The method as claimed in claim 2 wherein the high pressure is between about 5 and 30 bars.

4. The method as claimed in claim 1 wherein the nitrogen is replaced with an inert gas selected from the group consisting of helium, argon and mixtures thereof.

5. The method as claimed in claim 1 wherein the water from the produced water is driven through the semi-permeable membrane.

6. The method as claimed in claim 1 wherein the semi-permeable membrane is made from poly imides and polyvinyl carbonates.

7. The method as claimed in claim 1 wherein the concentrated produced water that is recovered from the pressurized nitrogen side of the forward osmosis unit is fed to a concentrator which will separate the nitrogen gas dissolved in the concentrated produced water from the concentrated produced water.

8. The method as claimed in claim 1 wherein the fresh water that is recovered from the pressurized carbon dioxide side of the forward osmosis unit is fed to a separation device.

9. The method as claimed in claim 1 wherein recovered carbon dioxide gas from the pressurized carbon dioxide side of the forward osmosis unit is fed to the separation device.

10. The method as claimed in claim 1 wherein the fresh water is further separated from the carbon dioxide gas in the separation device and recovered.

11. The method as claimed in claim 5 wherein the recovered carbon dioxide gas is combined with pressurized carbon dioxide gas before being fed to the pressurized carbon dioxide side of the forward osmosis unit.

12. The method as claimed in claim 1 wherein Phase II liquid is recovered from the separation device and fed to a concentrator unit.

13. The method as claimed in claim 12 wherein the Phase II liquid provides enhanced solubility of carbon dioxide.

14. The method as claimed in claim 12 wherein the Phase II liquid will form a two phase draw solution which under pressure from a carbon dioxide feed is fed to the forward osmosis unit.

15. The method as claimed 1 wherein the concentrated produced water from the concentrator is fed to a crystallizer or is discharged.

16. The method as claimed in claim 1 wherein the concentrator unit adjusts the concentrations of solutes in a draw solution.

17. The method as claimed in claim 1 wherein a gravity separator is present in the separation unit.

18. The method as claimed in claim 1 wherein the produced water contains around 150,000 parts per million dissolved salts.
